(19) United States
(12) Patent Application Publication
(10) Pub. No.: US 2018/0250805 A1
(43) Pub. Date: Sep. 6, 2018

(54) HOLDING APPARATUS HAVING AN INTEGRATED CONTACTLESS CHARGING STATION, FOR A STRAPPING DEVICE

(71) Applicant: Signode Industrial Group LLC

(72) Inventors: Dimitrios Takidis, Dubendorf (CH); Carmen Rutschi, Zurich (CH)

(21) Appl. No.: 15/746,952

(22) PCT Filed: Jul. 29, 2016
(86) PCT No.: PCT/IB2016/001077

§ 371 Date: Jan. 23, 2018

(30) Foreign Application Priority Data
Jul. 30, 2015 (CH) 01108/15

(51) Int. Cl. B25F 5/02; H01M 2/10; H01M 10/46; H02J 50/10; H02J 7/02; B65B 13/02

(52) U.S. Cl. CPC B25F 5/02; H01M 2/1022; B65B 13/025; H02J 50/10; H02J 7/025; H01M 10/46

(57) ABSTRACT

The problem addressed by the present disclosure is that of creating a possibility for a holding apparatus for a mobile strapping device, in which the mobile strapping device can be held in a predetermined position, which possibility allows strapping processes by way of mobile strapping devices to be made more productive. This problem is solved by a charging station integrated into the holding apparatus for charging a rechargeable battery of the strapping device inserted into the positionally accurate arrangement of the strapping device. In addition, a holder of the holding apparatus in which positioning mechanisms for the positionally accurate arrangement of the strapping device in the holding apparatus are arranged is provided, wherein, by way of the positioning mechanisms, the strapping device is arranged in the holding apparatus in such a way that the rechargeable battery arranged on the strapping device is in a predetermined charging position in relation to the charging station.

### PRIORITY CLAIM

This patent application is a national stage entry of PCT Application No. PCT/IB2016/001077, which was filed on Jul. 29, 2016, which claims priority to and the benefit of Swiss Patent Application No. CH 01108/15, which was filed on Jul. 30, 2015, the entire contents of each of which are incorporated herein by reference.

### TECHNICAL FIELD

The present disclosure relates to a holding apparatus for a mobile strapping device, in which the mobile strapping device can be held in a predetermined position.

### BACKGROUND

Mobile strapping devices are often provided with a rechargeable energy storage, especially with an electrical storage cell. Such a device is charged with electrical energy for purposes of its use, so that the driven components may then be supplied with energy. Usually the respective storage cell is used until it is discharged or at least for the most part discharged. Once this has occurred, the discharged storage cell is replaced by a charged storage cell and the discharged storage cell is recharged in a charging station for further use in a strapping device. At a given time, the recharged storage cell can be put back into a strapping apparatus and used to produce strappings.

The use of such strapping devices may occur at a distance from a charging station for storage cells. It may therefore be necessary, for the replacing of a discharged battery by a charged one, for the user of a mobile strapping device being used in production to go to a distant charging station and there insert a recharged battery in the strapping apparatus and recharge the discharged battery in the charging station. This process involves the drawback of a relatively large time expenditure during which the user cannot perform any strapping.

The present disclosure is therefore based on the problem of creating a possibility by which the strapping processes with mobile strapping devices can be made more productive.

### SUMMARY

This problem is solved according to the present disclosure by a holding apparatus of the kind mentioned at the outset with a charging station integrated in the holding apparatus for the charging of a rechargeable battery of the strapping device which is inserted into the strapping device, and also by a holder of the holding apparatus, in which a positioning mechanism is arranged for the positionally accurate arrangement of the strapping device in the holding apparatus, such that the strapping device is arranged by the positioning mechanism in the holding apparatus in such a way that the rechargeable battery arranged on the strapping device finds itself in a predetermined charging position in relation to the charging station. The problem is furthermore solved by a charging station and a strapping system as further described herein.

Thus, according to the present disclosure it is proposed to charge a rechargeable storage battery which is removably inserted in the strapping apparatus not in the conventional manner used for strapping apparatuses thus far, by removing the interchangeable storage battery and inserting the individual batteries in a charging station, but instead by inserting the entire apparatus together with the storage battery installed in the strapping apparatus into the charging station and charging it.

It is already known from the field of cordless screwdrivers—which is remote from that of strapping devices—how to arrange them together with their installed battery on a charging station such that the storage battery installed at a lower end of a handle of the cordless screwdriver and removable by the user lies together at the charging station on a tray surface of the charging station. Thus, the charging station bears the entire weight of the cordless screwdriver with the battery installed. In order to accomplish a correct orientation of the installed battery with respect to the charging station, the battery is placed in a guide of the charging station without a holding apparatus for the cordless screwdriver. By contrast with this, in the solution according to the present disclosure it is provided that the installed storage battery and the charging station do not have to bear the entire weight of the strapping device. Likewise, according to the present disclosure, the correct charging position of the storage battery relative to the charging station is advantageously achieved in that an orienting of the storage battery in the holding apparatus is done by orienting the strapping apparatus. It is especially favorable here in one embodiment of the present disclosure for the holding apparatus to be provided with mechanism by which the strapping device can be oriented in three different directions in space. These provided differences mean that the storage battery together with the strapping device can be arranged in a simple and fast manner in correct position relative to the charging station. This significantly improves the functional safety of the charging process.

The present disclosure furthermore enables a charging of the installed storage battery between consecutive strapping processes, i.e., during the use of the strapping device with storage battery installed in it. The strapping device for example may be charged between the performance of consecutive strappings by placing it against the charging station, in particular by inserting the strapping device into the holding apparatus according to the present disclosure. Thus, the present disclosure makes it possible to use the time between strapping processes, during which the strapping apparatus would formerly be set aside and idle, for an intermediate charging process during which a partial charging of the storage battery occurs. In this way, the useful time of a mobile strapping device and its storage battery is substantially increased until it needs to be replaced by another one.

In an especially favorable embodiment of the present disclosure, which also has independent significance even apart from a use of a holding apparatus, the charging station used can be a charging station designed for a contactless charging process. In this case, electrical energy is transmitted to the storage battery by arranging the storage battery in the region of one or more induction coils of the charging station. “Contactless” is understood to mean in this context “free of electrically conducting contacts”, i.e., in the sense of “wireless”. An electrically nonconducting contact between one or more electrically nonconducting surfaces of the rechargeable storage battery and the charging station, on the other hand, may be expressly desired and advantageous for assisting in a simple manner a correct orienting of the installed storage battery, by which an optimal charging process is achieved or a malfunction during the charging process can be prevented. Owing to the positioning mechanisms provided on the holding apparatus, it can be advantageously ensured that the storage battery when arranged in the holding apparatus comes to bear in a predetermined manner against one or more surfaces of the charging station. In contactless charging stations, one or more induction coils may be arranged, for example, behind such an outer surface and an alternating magnetic field can be generated by them. Likewise, in one or more coils in the storage battery, which is located in the charging position in the magnetic field of the at least one coil of the charging station, the magnetic field induces a voltage which produces a flow of current in the receiving coil, which is used for the charging of the storage battery.

An especially fast but nevertheless accurate orienting of the storage battery being charged and installed in the strapping device can be achieved by an arrangement of the strapping device in the holding apparatus in which the strapping device in its charging position bears by a base plate against the charging station. In this context, base plate is understood to mean the component or components on a mobile portable strapping device by which the particular strapping device is placed against the particular packaged goods or brought to bear against them during a strapping process. In an embodiment of the present disclosure, the strapping device and the holding apparatus may be attuned to each other such that the holding apparatus is configured to set down the strapping device on its base plate. Further, it may be provided advantageously that the holding apparatus is configured so that the strapping device is received by its base plate in a nonslip fashion in a predetermined position in the holding apparatus, for example, by a form fitting fixation of the base plate on the holding apparatus. Instead of or in addition to a fixation of the strapping device to its base plate, in other embodiments of the present disclosure there may be a fixation of the strapping device or the strapping apparatus itself to one or more of its other elements, for example by engaging on or against the housing, especially without using the installed battery or its storage cell for this. A fixation in this context is understood to mean that the strapping device finds itself in a predetermined definite position in the holding apparatus and can only be removed once more by lifting the strapping device. In this way, secure arrangement of the strapping device with its storage battery in the holding apparatus is possible, contributing to a functionally safe charging process of the storage battery in the holding apparatus. In particular, one may avoid any design features on the strapping device provided only for setting down the strapping device relative to the charging station.

In an embodiment of the present disclosure, the mobile strapping device may have a front region in which are arranged at least some or all of the mechanical elements of the strapping device, such as, for example, one or more gearings as well as the tightening wheel and also a vibration welding device. Moreover, the strapping device also has a rear region in which at least one holder for an interchangeable storage cell is provided. The front and rear region of the strapping device are joined together by way of a handle. Moreover, the present disclosure contemplates providing the front and the rear region of the strapping device with another housing region provided underneath and at a distance from the handle, likewise joining together the front and the rear region of one embodiment of the strapping device. At the bottom side of the strapping device in the position of use, there may be provided a base plate with a base plate rest surface. In order to provide packaged goods with a strapping, the strapping device is configured to be arranged with the base plate rest surface against the particular packaged goods so as to carry out the strapping process in this arrangement. The present disclosure further contemplates placing such a strapping device in a predetermined position in the holding apparatus by placing the base plate against the holding apparatus and/or against positioning mechanisms of the holding apparatus, such that the rear region of the strapping device finds itself with its battery/storage cell directly opposite the charging station in a charging position. Alternatively or in addition to the base plate, for the positionally correct arrangement of the strapping device in the holding apparatus the housing of the strapping device can also be configured to bear against positioning mechanisms of the holding apparatus, for example, the housing region located between the front and rear region of the strapping device which is provided underneath and at a distance from the handle.

According to another embodiment of the disclosure, it may be provided that the holding apparatus with the integrated charging station can be arranged on a movable cart, which forms a strapping system together with the holding apparatus and at least one strapping device. By way of such a cart, it is possible to carry along the holding apparatus together with the strapping device and thus charge the strapping device during its times of use in an operation. Thus, the storage battery can also be charged at least partially while being used in the strapping device.

The use of such a movable cart with charging station arranged thereon can be even further boosted if material needed for forming strappings can also be carried along with the cart. Thus, in particular, it may be provided that the cart has a holder for a supply of strapping band, especially a roll of strapping band. The holder for the band supply can be arranged in an especially expedient manner such that it provides the band supply in a predetermined orientation coordinated with the arrangement of the holding apparatus. This orientation may be such that a direction of pulling of the band supply runs at least substantially parallel to the intended direction of running of the band in the strapping device. In this way it is possible to pull the strapping band from the band supply in an ergonomically favorable manner and to insert it already into the strapping device arranged on the cart. Since a user of the strapping device no longer needs to hold the strapping device as previously for the forming of a band loop and introducing the band into the strapping device, the user has both hands free, so that the preparations for the strapping process can be performed in a secure and rapid manner.

Further embodiments of the present will emerge from the claims, the description, and the drawings.

### BRIEF DESCRIPTION OF THE DRAWINGS

The present disclosure shall be explained more closely with the aid of exemplary embodiments represented purely schematically in the figures. There are shown:

FIG. 1 a perspective representation of a holding apparatus according to the present disclosure, holding a wireless charging station, with a mobile strapping apparatus installed in it;

FIG. 2 an exploded representation of the holding apparatus and the corresponding strapping apparatus of FIG. 1;

FIG. 3 a perspective representation of the holding apparatus according to the present disclosure with wireless charging station installed therein;

FIG. 4 the holding apparatus and charging station of FIG. 3 in an exploded representation;

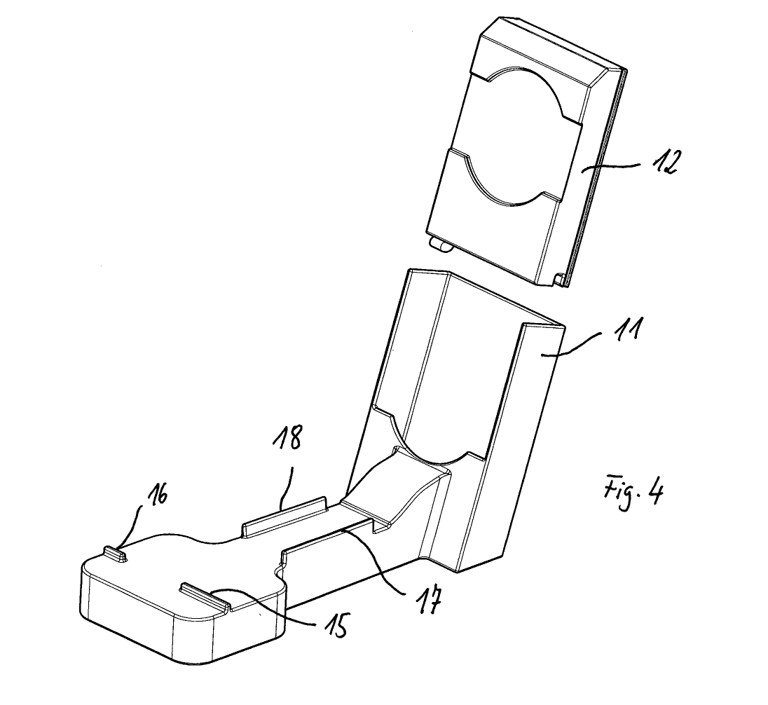

FIG. 5 a bottom side of the holding apparatus of FIG. 1;

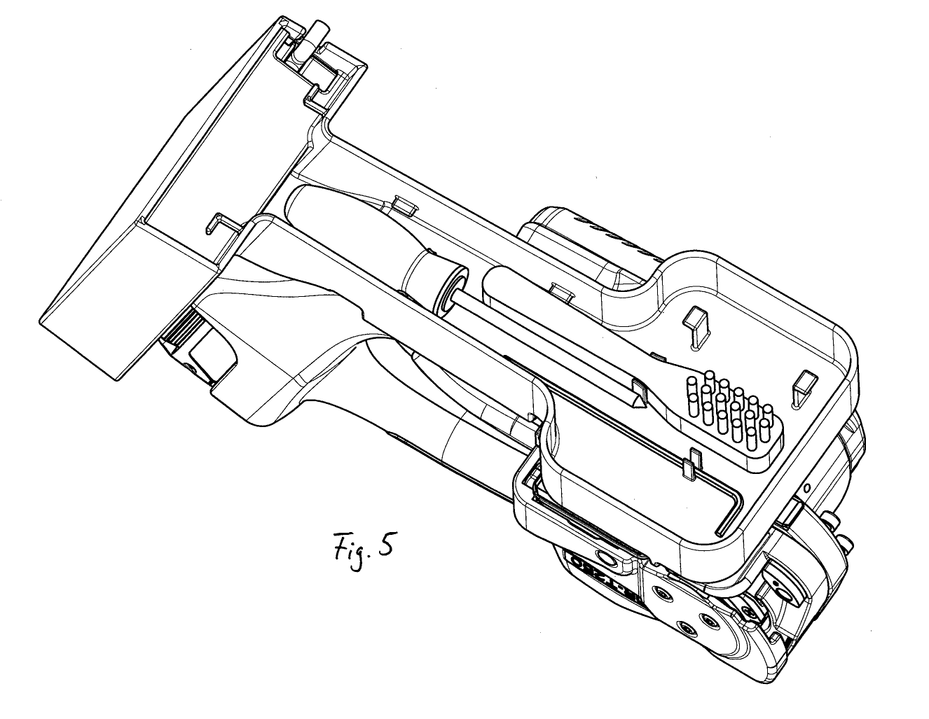

FIG. 6 an accessory device according to the present disclosure with a holding apparatus arranged on it and a strapping apparatus from FIG. 1 inserted therein.

### DETAILED DESCRIPTION

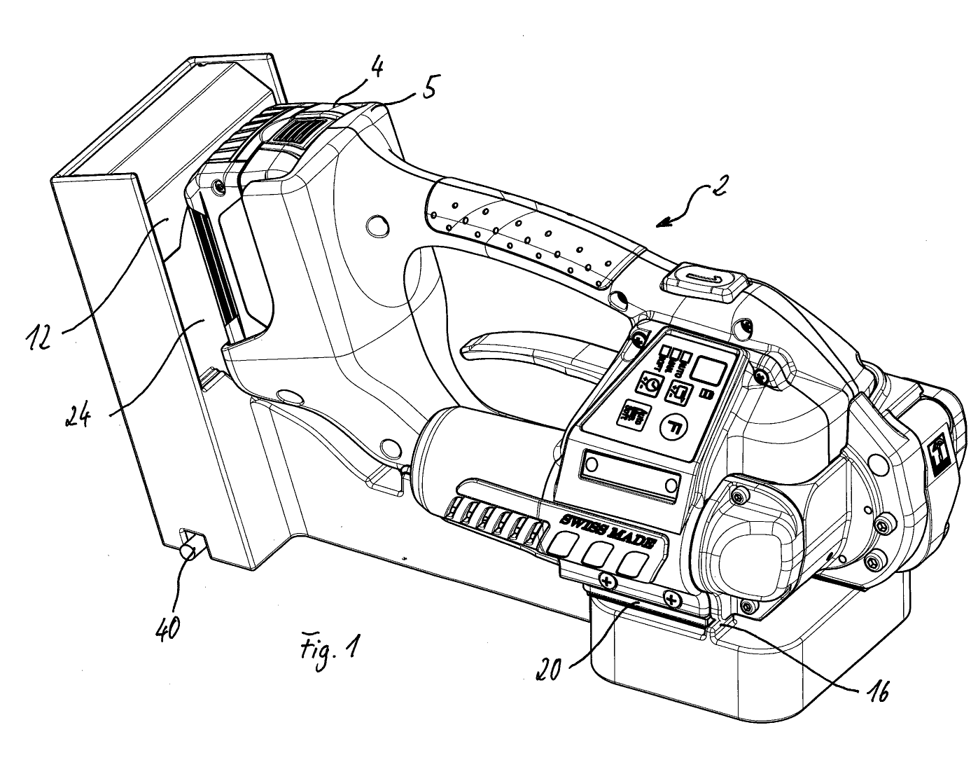

FIG. 1 shows an exemplary embodiment of a holding apparatus 1 according to the present disclosure for a mobile strapping apparatus 2. The holding apparatus 1 and the portable mobile strapping apparatus 2 are coordinated with each other in a manner to be further explained below. The strapping apparatus shown in FIG. 1 is configured to produce band straps in a known manner. For this, a band loop is placed around the particular packaged goods, especially but not exclusively a plastic band 3. A region of the band loop in which two layers of the band loop are arranged one on top of the other is introduced into the strapping apparatus 2, the band of the band loop is placed by way of a tightening device of the strapping apparatus 2 against the packaged goods, tension is applied to the band and then the band loop is connected and closed by way of a closure device of the strapping apparatus. Such strapping apparatuses 2 provided with a tightening and a closing device are already known per se in many varieties.

Such band strapping apparatuses need to be supplied with energy, especially to drive their tightening and closing devices. One widespread option for this is to provide electrical energy through a storage cell 4 installed in the strapping apparatus, by which one or more electric motors can be driven. In the exemplary embodiment, the storage cell 4 is inserted into a holder 5 of the strapping apparatus 2 in a predetermined position on the strapping apparatus 2. The storage cell 4 can be removed from the strapping apparatus 2 and replaced with another storage cell (not shown). In other embodiments according to the present disclosure, the storage cell could also be permanently installed in the strapping apparatus.

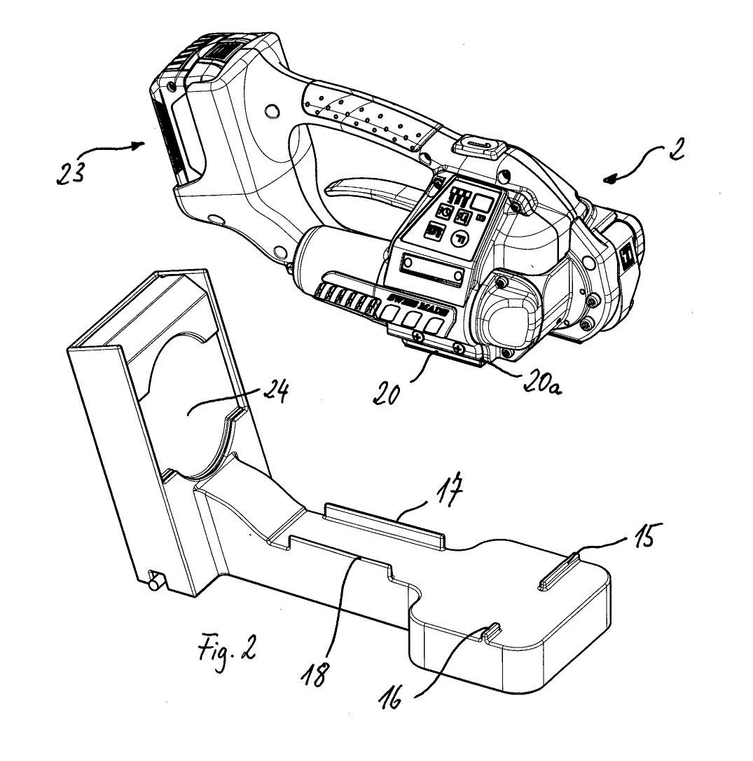

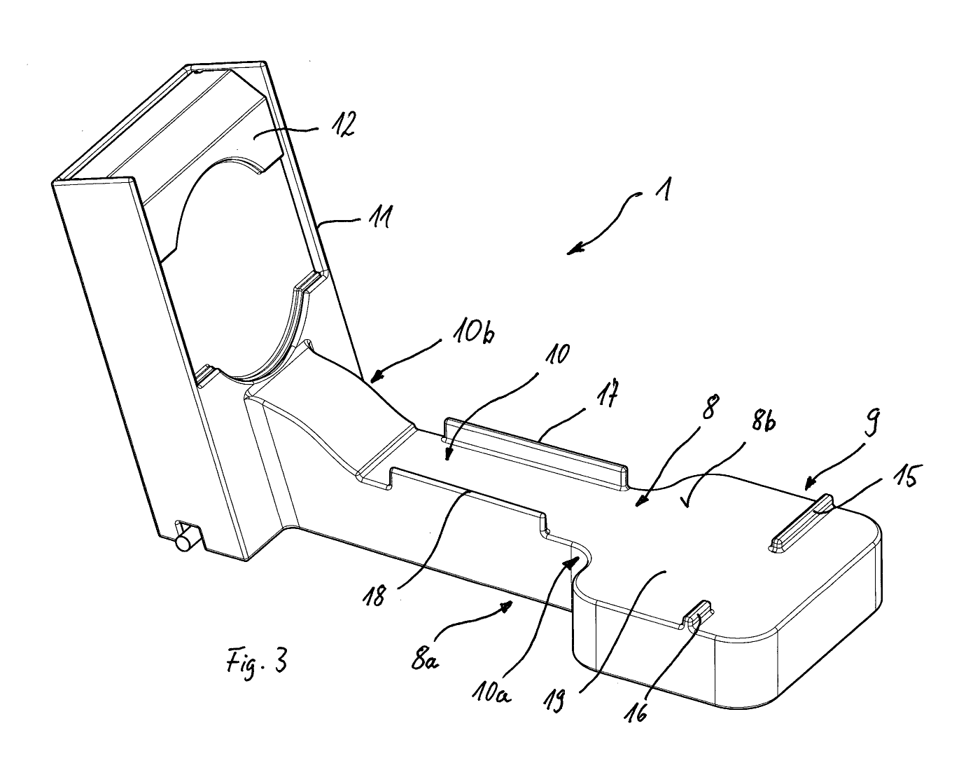

The holding apparatus 1 shown in FIGS. 2 and 3 has a holding piece, which in the exemplary embodiment is configured as a stowing plate 8. The stowing plate in its intended position of use is oriented substantially horizontal and has a flat bottom 8a, by which the holding apparatus 1 can be set down on a corresponding base. An outer shape of the top 8b of the stowing plate 8 is adapted to the shape of the bottom of the strapping apparatus. The surface of the top 8b is fashioned approximately in a T or hammer shape in regard to a plan view. A front region 9 of the stowing plate 8 has a greater width than an adjoining web part 10, which is provided with a substantially constant width. At its rear end region 10b, facing away from the front end 10a, the surface of the top side 8b rises in a ramp-like manner. Adjoining this rear end 10b of the web piece 10 is a holder piece 11 for a charging station 12. The holder piece 11 is approximately cuboidal and raised in relation to the stowing plate 8 and its bottom side. An angle α, by which the holder piece 11 is raised in relation to the bottom side 8a, is adapted to the arrangement of the storage battery 4 in the strapping apparatus 2 and may be chosen for example in the range of 90° to 140°.

In the holder piece 11 is provided a charging station 12 for the wireless charging of storage cells 4 inserted and arranged in the strapping apparatus 2. Such a charging station 12 for the wireless or contactless charging of storage cells is available from the firm Robert Bosch GmbH, 70839 Gerlingen-Schillerhöhe. The charging station 12 is a wireless charging station, in which electrical energy can be transmitted to the battery or storage cell by placing a battery or storage cell, likewise configured for wireless energy transmission, in a position near the charging surface of the charging station.

In the exemplary embodiment of the figures, the stowing plate 8, the web piece 10 and the holder piece 11 are joined together as a single piece, for example as a single component of injection molded plastic.

On the top side of the stowing plate 8 there are provided positioning mechanisms in the form of several webs 15, 16, 17, and 18, protruding from the top side 8b. In other embodiments of the present disclosure, elements other than webs may also be provided as the positioning mechanisms. In the region of the web piece 10, two webs 15, 16 from the top side. In the exemplary embodiment, these two webs 15 and 16 run in a straight line, parallel to each other, and are arranged at a distance from each other in the region of opposite longitudinal edges of the web piece 10. The two webs 15 and 16 furthermore have a constant height in relation to the top side.

Another two webs 17 and 18 protruding from the top side 8b are arranged in the region of the base plate rest 19 of the stowing plate 8. These two webs 17 and 18 are arranged in a common alignment and run parallel to each other. They are furthermore oriented at least approximately perpendicular to the extension of the webs 15 and 16 of the web piece 10.

The position, orientation and extension of the webs is configured so that the base plate 20 of the strapping apparatus, lying against the base plate rest 19, rests by its front longitudinal edge 20a against the two webs 17 and 18 of the base plate rest 19. The base plate 20 here is the component of the strapping apparatus 2 by which the strapping apparatus 2 is configured to rest against the particular packaged goods during strapping processes by the bottom side of the base plate 20. The base plate 20 of a strapping device is usually located in the region of the tightening and closing device and can serve by its top side as a support for the strapping band during the tightening and/or closing process. Since the particular strapping apparatus 2 and the particular holding apparatus 1 are coordinated with each other in terms of their geometrical design, the storage battery 4 installed in the ready-to-use strapping apparatus will come to bear in this position, at least by one of its surfaces, namely a rear, freely accessible contact surface 23, against the charging surface 24 of the charging station 12. In order to carry out the charging function with the desired charging result, the contact surface 23 should also advantageously be oriented in a direction transverse to the longitudinal extension of the strapping apparatus 2, so that the largest possible overlap between the charging surface and the contact surface can also be created in regard to this direction. The two webs 15 and 16 of the web piece 10 are configured for such a positionally correct orientation, the spacing between which is configured so that this spacing corresponds at least roughly to the width of the strapping apparatus 2 on its bottom side in a region between its head region and its battery holder. The webs 15 and 16 are coordinated in regard to the charging surface 24 of the charging station 12 arranged in the holder piece 11 so that the contact surface 23 of the storage battery 4 is oriented and positioned in the predetermined manner also in a direction running at least substantially transversely to the direction of longitudinal extension of the strapping apparatus. By the positioning mechanisms of the holding apparatus, the strapping apparatus 2 and the storage cell 4 installed therein can be placed in its charging position and charged in a fast, accurately replicable, and functionally safe manner.

The strapping apparatus in this case should be arranged with the mentioned region between the two webs 15 and 16 having the least play possible. Furthermore, it is advantageous for the two webs 15 and 16 to have a length such that the strapping apparatus not only cannot shift to the side, but also is firm against rotational movements on the surface of the top side 8b of the stowing plate 8. By placing the strapping apparatus 2 on or in the holding apparatus 1, the strapping apparatus 2 is oriented positionally accurate with respect to the charging surface 24 also in a direction perpendicular to the base plate. Thus, the holding apparatus 1 produces an orienting of the strapping apparatus 2 and its storage battery 4 in all three directions in space with respect to the charging station 12.

With the strapping apparatus inserted thus in the holding apparatus, the storage battery of the strapping apparatus can be charged by the charging station each time it is inserted into the holding apparatus.

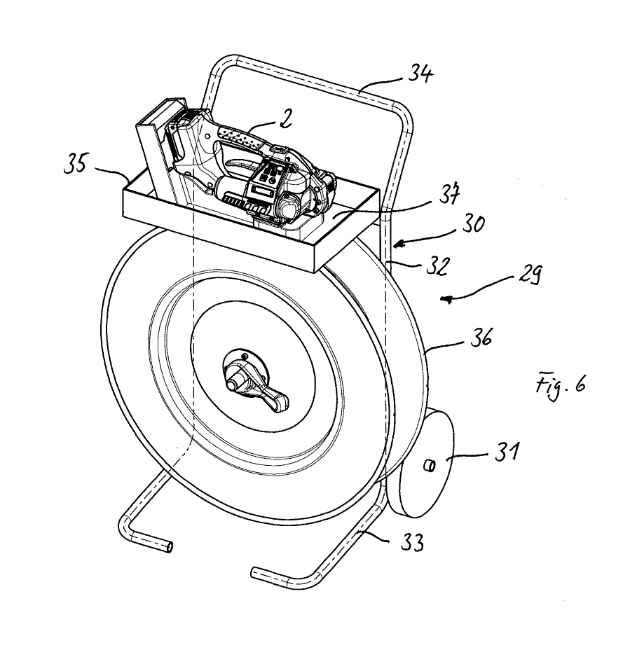

FIG. 6 shows a mobile accessory device 29 for the producing of strappings. This is configured in the exemplary embodiment as a kind of movable cart 30, being provided with at least two wheels and a standing aid 33 formed on a frame 32 of the cart 30, by which the cart 30 can be parked for a stable arrangement on a base surface. The accessory device 29 can be pushed by a handle 34. Furthermore, the accessory device 29 is provided with a holder 35 for a strapping band roll 36 only suggested in FIG. 6, on which such a roll 36 can be arranged. The roll 36 is mounted rotationally on the holder 35, so that strapping band can be pulled off from the roll.

Directly above the roll and in the region of the handle 34 there is arranged on the accessory device 29 a tray 37, which is configured to receive the holding apparatus 1. The holding apparatus 1 can be set down on the tray 37. Suitable mechanisms (not shown) are provided for this on the tray 37, in order to arrange the holding apparatus on the tray releasably in a predetermined position. In other expedient embodiments of the present disclosure, the holding apparatus 1 may also be connected nonreleasably to the tray 37 or also be placed only loosely thereupon.

The holding apparatus 1 may be configured advantageously in regard to the holder 35 for the band supply such that a designated band run of a strapping apparatus 2 inserted in the holding apparatus runs at least roughly parallel to a horizontal tangent on the strapping band roll 36. Owing to this orientation, a strapping process can be prepared in an especially easy manner. A strapping band pulled off from the roll can easily be inserted in the strapping apparatus already in an exact orientation owing to the orientation of the band on the roll, already with the strapping apparatus still inserted in the holding apparatus. For this, the band does not need to be moved out from the unrolling plane of the supply roll, or at most only slightly so.

Furthermore, the charging station 12 is provided with a power connection 40, by way of which the charging station can be connected to an external power supply. The power connection 40 may be in particular a standardized plug, which fits the typical receptacles of the particular country. Thus, the charging station 12 can be powered with the particular alternating current available from the power grid. The strapping accessory device 29 formed as a cart 30 can thus be pushed from one place to another during an operation, for example in a production bay, and at each place it can be connected to the closest outlet as needed, so that the ready-to-operate strapping apparatus 2 can also be charged by its storage battery 4 during the intervals of using the ready-to-operate strapping apparatus in that the strapping apparatus when not in use is inserted into the holding apparatus connected to the power mains and arranged on the cart.

### LIST OF REFERENCE NUMBERS

1 Holding apparatus

2 Strapping apparatus

3 Plastic band

4 Storage cell

5 Holder

8 Stowing plate

8a Bottom side

8b Top side

9 Front region

10 Web piece

10a Front end

10b Rear end region

11 Holder piece

12 Charging station

15 Web

16 Web

17 Web

18 Web

19 Base plate rest

20 Base plate

20a Front lengthwise edge

21

23 Battery contact surface

24 Charging surface

29 Accessory device

30 Cart

31 Wheels

32 Frame

33 Standing aid

34 Handle

35 Holder

36 Strapping band roll

37 Tray

40 Power connection

1-17. (canceled)

18. A holding apparatus for a mobile strapping device having a rechargeable battery, the holding apparatus comprising:
a charging station configured to charge the rechargeable battery of the mobile strapping device; and
a holder connected to the charging station and configured to receive and orient the mobile strapping device such that the rechargeable battery is in a charging position relative to the charging station when the mobile strapping device is received by the holder.

19. The holding apparatus of claim 18, wherein the charging station comprises a contactless charging station.

20. The holding apparatus of claim 18, wherein the holder comprises a positioning mechanism positioned to contact a base plate of the mobile strapping device when received in the holder and to orient the mobile strapping device such that the rechargeable battery is in the charging position.

21. The holding apparatus of claim 20, wherein the holder comprises a stowing plate and the positioning mechanism extends from the stowing plate.

22. The holding apparatus of claim 20, wherein the positioning mechanism includes two spaced apart first webs extending transversely from a top surface of the holder and two spaced apart second webs extending from the top surface of the holder and oriented transversely to the first webs.

23. The holding apparatus of claim 18, wherein the charging station is removably positioned in a charging station holding piece connected to the holder.

24. The holding apparatus of claim 18, wherein the charging station extends transversely from the holder.

25. The holding apparatus of claim 24, wherein the charging station extends transversely from the holder at an angle between 90 degrees and 140 degrees.

26. The holding apparatus of claim 18, wherein the charging station is positioned in a charging station holding piece that extends transversely from the holder at an angle between 90 degrees and 140 degrees.

27. The holding apparatus of claim 18, wherein the holder and the charging station are oriented such that the holder bears all of the weight of the mobile strapping device when the mobile strapping device is received by the holder.

28. The holding apparatus of claim 18, wherein the holder and the charging station are oriented such that the charging station does not bear any of the weight of the mobile strapping device when the mobile strapping device is received by the holder.

29. A strapping system comprising
a movable cart; and
a holding apparatus mounted to the movable cart and comprising:
a charging station configured to charge a rechargeable battery of a mobile strapping device; and
a holder connected to the charging station and configured to receive and orient the mobile strapping device such that the rechargeable battery is in a charging position relative to the charging station when the mobile strapping device is received by the holder.

30. The strapping system of claim 29, wherein the movable cart is configured to hold a strap supply.

31. The strapping system of claim 30, wherein the holding apparatus is mounted to the movable cart such that the holding apparatus is approximately aligned with a direction of pulling of strap from the strap supply.

32. The strapping system of claim 31, wherein the charging station comprises a contactless charging station.

33. The strapping system of claim 31, wherein the holder comprises a positioning mechanism positioned to contact a base plate of the mobile strapping device when received in the holder and to orient the mobile strapping device such that the rechargeable battery is in the charging position.

34. The strapping system of claim 33, wherein the holder comprises a stowing plate and the positioning mechanism extends from the stowing plate.

35. The strapping system of claim 31, wherein the charging station is removably positioned in a charging station holding piece connected to the holder.

36. The strapping system of claim 31, wherein the charging station extends transversely from the holder.

37. The strapping system of claim 31, wherein the charging station extends transversely from the holder at an angle between 90 degrees and 140 degrees.

38. The strapping system of claim 31, wherein the charging station is positioned in a charging station holding piece that extends transversely from the holder at an angle between 90 degrees and 140 degrees.

39. The strapping system of claim 31, wherein the holder and the charging station are oriented such that the holder bears all of the weight of the mobile strapping device when the mobile strapping device is received by the holder.

40. The strapping system of claim 31, wherein the holder and the charging station are oriented such that the charging station does not bear any of the weight of the mobile strapping device when the mobile strapping device is received by the holder.
